(19) United States
(12) Patent Application Publication
(10) Pub. No.: US 2010/0027768 A1
(43) Pub. Date: Feb. 4, 2010

(54) AVIATION TEXT AND VOICE COMMUNICATION SYSTEM

(76) Inventor: James J. Foskett, Rockford, IL (US)

Correspondence Address: MCGUIREWOODS, LLP, 1750 TYSONS BLVD, SUITE 1800, MCLEAN, VA, 22102, US

(21) Appl. No.: 11/934,607

(22) Filed: Nov. 2, 2007

Related U.S. Application Data
(60) Provisional application No. 60/864,329, filed on Nov. 3, 2006.

(51) Int. Cl. H04M 11/00; G10L 15/26

(52) U.S. Cl. 379/88.14; 704/235

(57) ABSTRACT

A communication system provides the conversion of voice inputs into analog and/or digital data at either the transmission or reception end or both. The data is converted for use as voice and/or visual text which can be displayed to the operator for task specific or general information. This data can also be utilized by integrated management and display systems within a vehicle such as an aircraft, or for any broader communication or navigational purpose.

### CROSS-REFERENCE TO RELATED APPLICATIONS

This application claims priority to U.S. Provisional Patent Application No. 60/864,329 filed Nov. 3, 2006, and entitled “AVIATION TEXT AND VOICE COMMUNICATION SYSTEM,” the disclosure of which is incorporated by reference herein in its entirety.

### BACKGROUND OF THE INVENTION

1. Field of the Invention

This invention generally relates to communication systems and, more particularly, to aviation communications systems for use between air traffic control (ATC) and aircraft crew members.

2. Related Art

Current radio communications in aircraft control situations, by their nature, are limited to speech and hearing, typically without the benefit of visual cues or other types of enhancement. This is particularly problematic in aviation communications where many commands are issued to various planes on the same frequency in a short, congested period of time and particularly in those instances where proper compliance with each command is very important. Miscommunication of control, or even general information, may easily lead to all sorts of undesirable situations, including disastrous results.

Nearly all types of aviation currently use verbal radio communications. For example, all Air Traffic Control (ATC) instructions for both Visual Flight Rules (VFR) and Instrument Flight Rules (IFR) operations are routinely acknowledged by the pilot or crew member by verbally reading back the instruction in full. This is to confirm understanding and acceptance of the instruction and reduce the possibility of miscommunication between pilot and controller. However, this is often difficult since the commands are only processed by the pilots based only on their ability to properly process the commands that they hear verbally over the radio. For example, if the pilots are hindered by language skills (e.g., a non-native English speaking pilot conversing with a native English speaking traffic controller), the reliability or accuracy of the interpretation of commands or information may be impacted. Even impaired radio communications (e.g., static background noise) can cause a misunderstanding of a message or command.

FIG. 1 is a functional block diagram according to the prior art showing typical state of communications for ground control and plane interaction. Air traffic control (ATC), generally designated as 100 typically has communication facilities for a controller that might include a voice transmitter 105 with microphone 115, a voice receiver 110 with speaker 120 in radio communication 149a, 149b with a vehicle such as an aircraft, generally designated as 150. The aircraft may include a voice receiver 155 with a speaker 165, a voice transmitter 160 and microphone 170, all for use by a crew member, such as a pilot, to communicate with the controller at the ATC. The bi-directional communications 149 is typically voice based and is often subject to various types of problems such as noise, atmospheric interference and general quality degradation due to various other common sources (e.g., weather, day/night time transmission factors such as propagation, and the like).

Even in situations where both the pilot and ground controller have good and compatible language skills, it would greatly enhance the safety and reliability of the receipt and processing of the ATC commands, for example, if the pilot were provided with an added level of communication in addition to verbal communications to achieve a greater degree of accuracy and reliability in ground to plane and plane to ground communications so that incidences of miscommunication are significantly lowered.

### SUMMARY OF THE INVENTION

The system and methods of the invention in one or more of the embodiments described herein provides improved bi-directional communication between planes and ground controllers including verbal translation or confirmation of the spoken ATC commands in textual format, either as textual English or textual translated foreign language. The improved bi-directional communication contributes to improved flight control and overall flight safety. These and other advantages of the inventions, as well as additional inventive features, will be apparent from the description of the inventions provided herein.

In one aspect, a system for providing enhanced communication between a control center and a vehicle is provided that includes a voice to text converter to convert a voice based message to a text based message, an output display unit in the vehicle configured to display the text based message converted from the voice based message and a speaker configured to audibly deliver the voice based message.

In another aspect, a method of providing enhanced communications between a controller and a vehicle is provided including the steps of translating a voice message to a text message, displaying the text message converted from the voice message, and outputting the voice message to a speaker, wherein the outputting of the voice message and the displaying of the text message occur substantially at the same time.

In yet another aspect, a method of providing enhanced communications between a controller and an aircraft is provided. The steps of the method include receiving a voice message at the aircraft, translating the voice message to a text message, determining a confidence level of the translating, and outputting the text message, the confidence level and the voice message substantially at the same time for use by a crew member of the aircraft.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a functional block diagram according to the prior art showing typical state of communications for ground control and plane interaction;

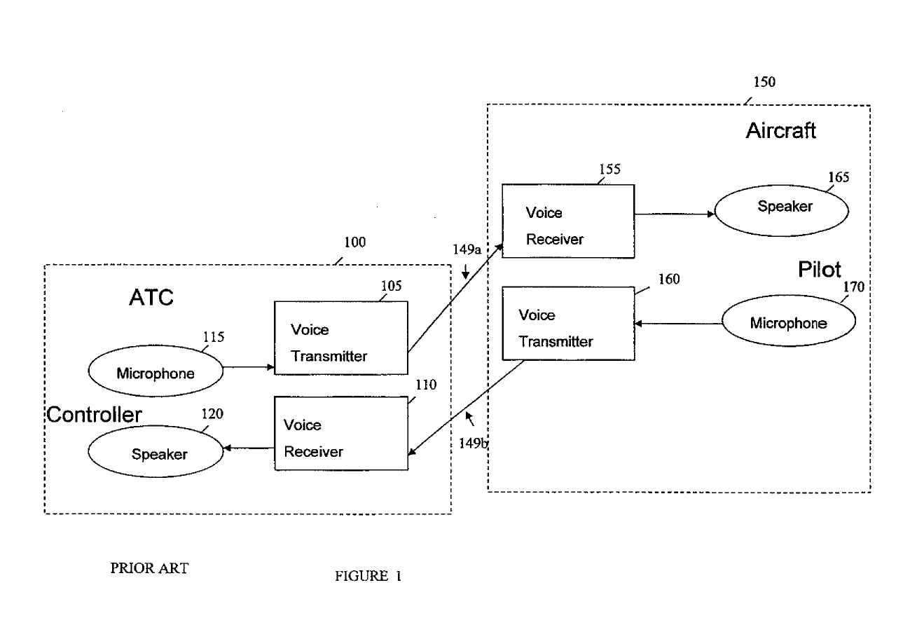

FIG. 2 is a functional block diagram illustrating an embodiment of a system for communications, according to principles of the invention;

FIG. 3 is a functional block diagram illustrating an embodiment showing a system for communicating including an optional text to text and/or text to voice translator, according to principles of the invention;

FIG. 4 is a functional block diagram showing another embodiment of a system, according to principles of the invention;

FIG. 5 is a functional block diagram showing yet another embodiment of a system for communications, according to principles of the invention;

FIG. 6 is a functional block diagram of still another embodiment of a communications system according to principles of the invention;

FIG. 7 is an embodiment of a communications system including a text to voice translation component, according to principles of the invention;

FIG. 8 is a functional block diagram showing an embodiment of a system for communication having a message confirmation loop, according to principles of the invention; and

FIG. 9 is a flow diagram showing steps of an embodiment for using a communication system, according to principles of the invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

It is understood that the invention is not limited to the particular methodology, protocols, devices, apparatus, materials, applications, etc., described herein, as these may vary. It is also to be understood that the terminology used herein is used for the purpose of describing particular embodiments only, and is not intended to limit the scope of the invention. It must be noted that as used herein and in the appended claims, the singular forms “a,” “an,” and “the” include plural reference unless the context clearly dictates otherwise.

Unless defined otherwise, all technical and scientific terms used herein have the same meanings as commonly understood by one of ordinary skill in the art to which this invention belongs. Preferred methods, devices, and materials are described, although any methods and materials similar or equivalent to those described herein can be used in the practice or testing of the invention.

The system and methods of the invention are directed to generally providing enhanced reliability and efficiency over present technologies with an added benefit of improving aviation safety in general. The principles of the invention include application of voice to text technology, text to voice technology, and text to text language conversion which greatly enhances two way radio communications and its reliability and serves specific needs and purposes as never before done.

The system and methods of the invention include the conversion of voice inputs into analog (e.g., radio wave) and/or digital data at either the transmission or reception end. In one aspect, the voice is converted for use from voice to visual text which can be displayed to both the sending and receiving operators (e.g., a pilot and ground controller) for task specific or general information. In other applications, this data can also be utilized by integrated management and display systems within a vehicle, or for any broader communication or navigational purpose.

However, voice to text radio transmission technology enables a pilot to both hear and see (e.g., in text or graphics) instruction or other given instructions. Furthermore, the information remains easily accessible to the pilot (or other crew member) should it again be required during the flight. This has several benefits. For example, the less experienced pilot has the added visual modality available, thereby decreasing pilot requests for repeat transmissions from ATC. Another benefit includes a reduction in frequency congestion by eliminating the need for a full verbal read-back of instructions by the pilot, as is the operating standard and convention of controller/pilot communications today. According to principles of the invention, the pilot simply acknowledges instructions by pressing an “acknowledgement button” or otherwise acknowledging the command, e.g., “roger,” without a full verbal read-back. These exemplary benefits significantly reduce frequency congestion, a problem of growing proportions in aviation.

The pilot is alerted visually that the controller spoken transmission is intended for his/her aircraft by a script type and script color alert that is attached to that aircraft's identification number. This is a significant advantage as one of the difficulties (problems) of air traffic communications presently, is several pilots/aircraft speaking simultaneously with the same controller on one frequency. Although the controller prefaces each command with the aircraft's identifier so that the pilot might understand that the commands are for his/her flight, pilots often miss this or are unsure if the command was meant for them; this situation is exacerbated due to increasing rapidity of spoken aviation communication and other inherent language factors.

The added visual modality of communication provided by the invention reduces the need for ATC information or directions to be repeated because too much information was spoken too quickly for the pilot to comprehend and/or momentary radio quality being reduced. The addition of text to aviation radio transmissions reduces the potential for miscommunication, thereby improving aviation safety for all users while lowering operator workload and stress. This augmentation of audio standard aviation English with textually translated and visually presented words of non-English speaking international airline pilots in their native language may enable significant improvements in the safety, reliability and efficiency of their communications. Radio type communications are enhanced through the use of voice to printed text and/or graphic technologies. The addition of a redundant component with concurrent visual text should vastly improve the quality of communications. This is especially important in environments where rapid and accurate communications are vital, such as in the aviation industry. Voice to text (and text to voice) language translation, for pilots and air traffic controllers who do not speak English as their primary language, would greatly increase the ease, efficiency and safety of international air traffic where English is the standard spoken language world wide. In certain embodiments, non-English speaking pilots have the added benefit of both hearing the spoken English broadcast (message or command) and simultaneously reacting to it in their native language on a text direction in the cockpit, for example. In addition to acting as a safety net to crew members and controllers who speak different native languages, this enhanced mode of communications may also help to reinforce the non-English speaking pilot's (or the non-English speaking controller's) learning of English while on the job.

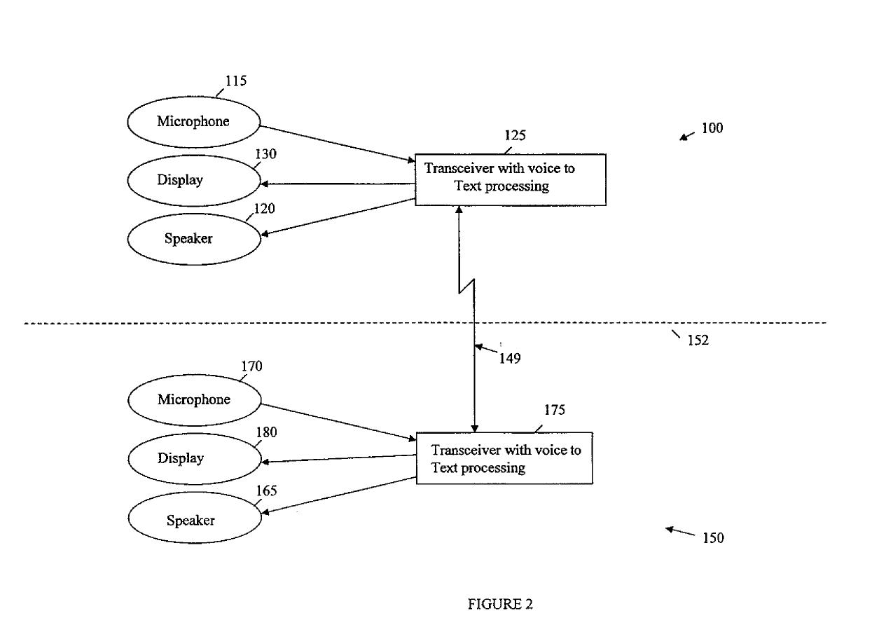

FIG. 2 is a functional block diagram illustrating an embodiment of a system for communications, according to principles of the invention. The functional block diagrams herein may also represent functional flow diagrams showing steps of performing or using the invention.

In FIG. 2, the ground control portion of the system is designated as 100 and the aircraft portion of the system is designated as 150. The demarcation line 152 logically separates these two system portions 100, 150. The bi-directional communications between the two system portions is generally designated by reference numeral 149. As illustrated in FIG. 2, voice commands or information may be converted into its corresponding text, at either the ground transmitting or the airborne receiving radio station, and is output to the end user as voice with its corresponding written text visually displayed. The ground based transceiver 125 may include a voice to text processing component for outputting text (perhaps with graphics) to display device 130. The airborne based transceiver 175 may also include a voice to text processing component for outputting converted voice to text (which might include graphics) to display 180. The speed of such translation or conversion is enhanced based on the somewhat limited and pre-defined vocabulary used in the aviation industry, thereby enhancing its reliability and accuracy.

Several options generally exist for the display of text information. A text display such as 130, 150 may be incorporated into a transceiver control panel, remotely located or output via the integrated display systems such as those used today in modern aircraft design. The display may be an LCD, plasma, or cathode ray tube type of display, for example. Text data may be further utilized for input to relevant aircraft navigation, monitoring and control systems. For example, a radio frequency value transmitted by ATC and received by the pilot is recognizable by the aircraft's integrated avionics and placed into the appropriate area for activation and execution by the pilot. This system utilizes analog and/or digital radio technologies for information transfer.

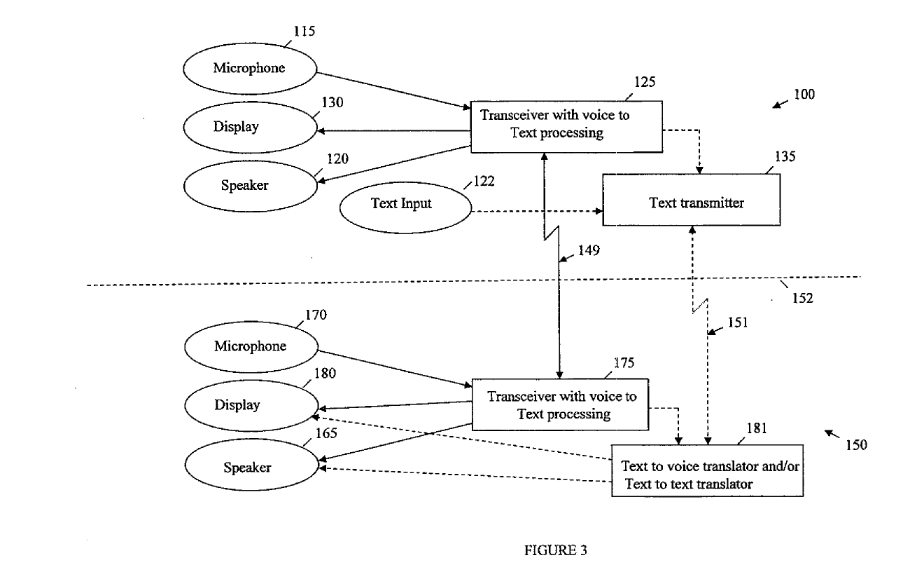

FIG. 3 is a functional block diagram illustrating an embodiment showing a system for communicating including an optional text to text and/or text to voice translator. This embodiment is similar to the embodiment of FIG. 2 except that a text transmitter 135 may be employed (or may be integral with the transceiver 125) with a text receiver and translator 181 in communication by communications link 151. Alternately, the text may be directly input as text from a text input device 122 to a text transmitter 135 without being translated from voice by transceiver 125. Furthermore, the translator 181 may be configured to receive a text message from the transceiver 175, in an alternate mode.

The translator 181 may translate the incoming text to voice (typically in a language native or familiar to the recipient) for output to the speaker 165. Moreover, the translator 181 may, in addition to or as an alternate mode of operation, translate the incoming text received in one language to a text of another language for display on display unit 180.

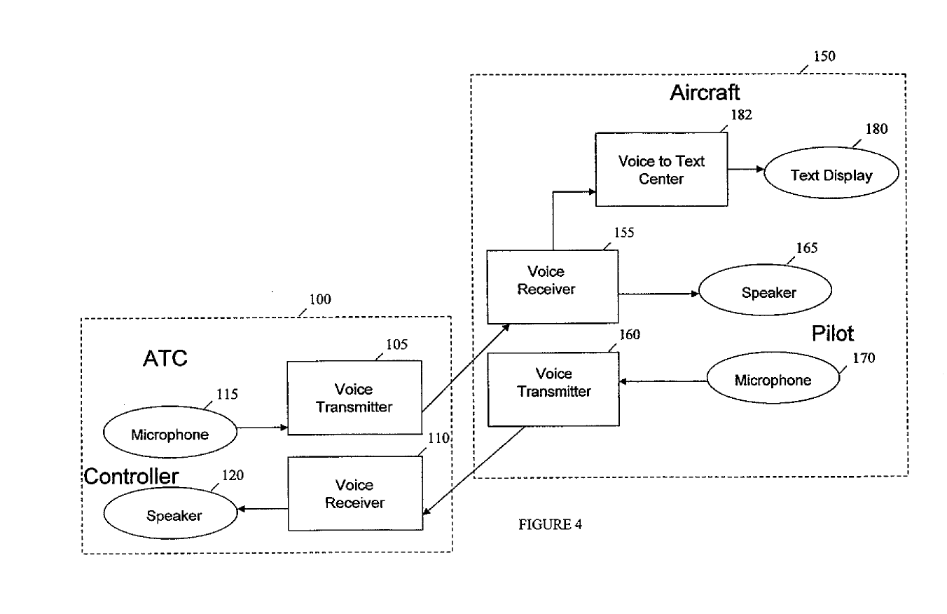

FIG. 4 is a functional block diagram showing another embodiment of a system, according to principles of the invention. At the ground control portion 100, a voice transmitter 105 receives voice input from the microphone 115 and initiates voice transmission to a voice receiver 155 on the aircraft 150. The voice may be translated to text at a voice to text center 182 and output to display 180.

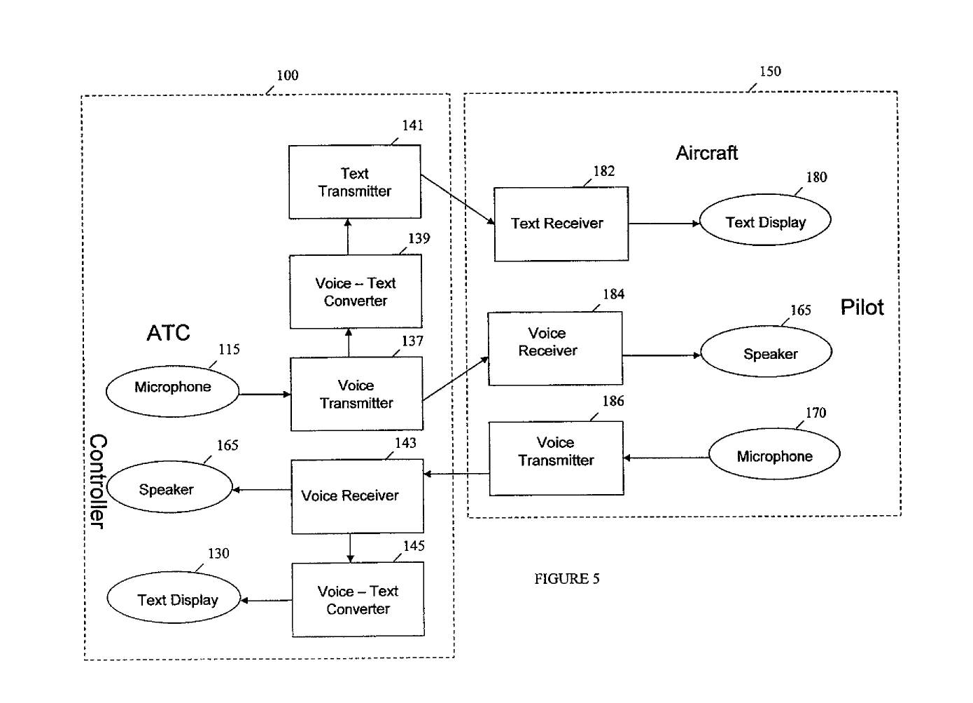

FIG. 5 is a functional block diagram showing yet another embodiment of a system for communications, according to principles of the invention. Voice from microphone 115 may be captured by a voice transmitter 137 and output to a voice to text converter 139 (language options may be user-selectable) for transmission by a text transmitter 141 to a vehicle such as an aircraft 150. The voice transmitter 137 may also transmit the voice to a voice receiver 184 for output to a speaker 165, typically substantially simultaneous with the output to the voice to text converter. The voice to text converter 139 may output the text to a text transmitter 141 for initiation of communications to the text receiver 182 on-board the aircraft 150 for display on the display unit 180.

Also at the ground control portion 100, a voice receiver 143 may receive voice transmissions from a voice transmitter 186 on the aircraft 150 for output to a speaker 165 and also to a voice to text converter 145 for display of the text on display 130. The voice receiver may output the voice to a voice to text converter 145 for display on display 130. In this way, the voice and text outputs are substantially simultaneous for use by a controller or other personnel.

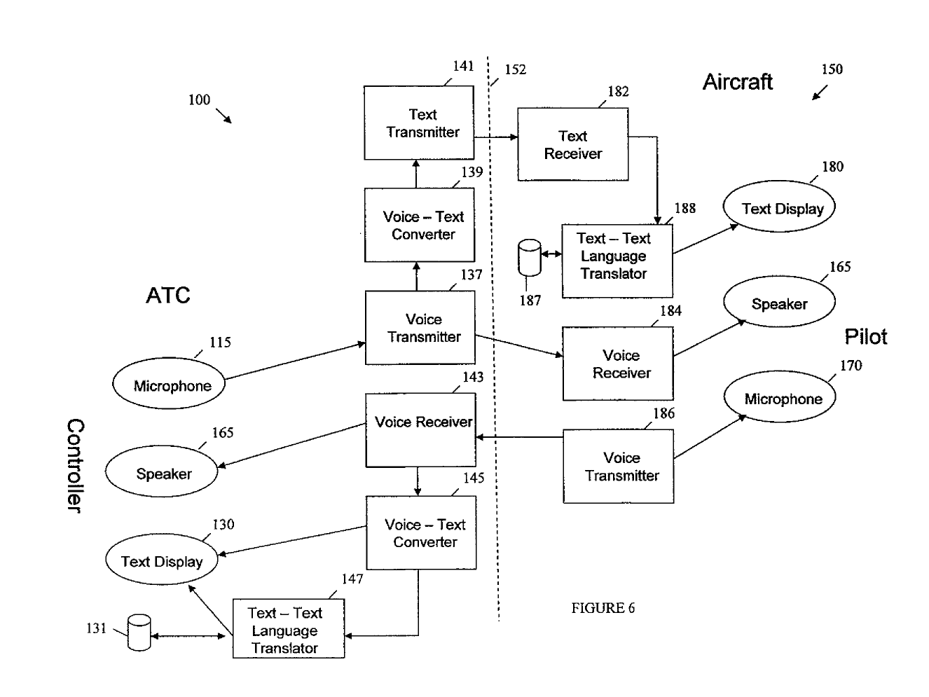

FIG. 6 is a functional block diagram of still another embodiment of a communications system according to principles of the invention. This embodiment is similar to the embodiment of FIG. 5 except that a text to text translator 147 translates the converted text from the voice to text converter 145 to another language, perhaps in those situations where a record may be needed (e.g., stored in database 131 for recall) or where another version of a language may be needed (perhaps where there may be two receiving people (e.g., two ground controllers with different language skills). Also, a text to text language translator 188 translates text to another language for display and/or storing in a database 187 for historical recall by a crew member, or other personnel. Again, two languages may be provided to the aircraft personnel. Additionally, upon user request, the text to text translator 147, 188 may be called upon to translate and display any particular message to still another language, if needed, by recalling a stored message from database 131, 187.

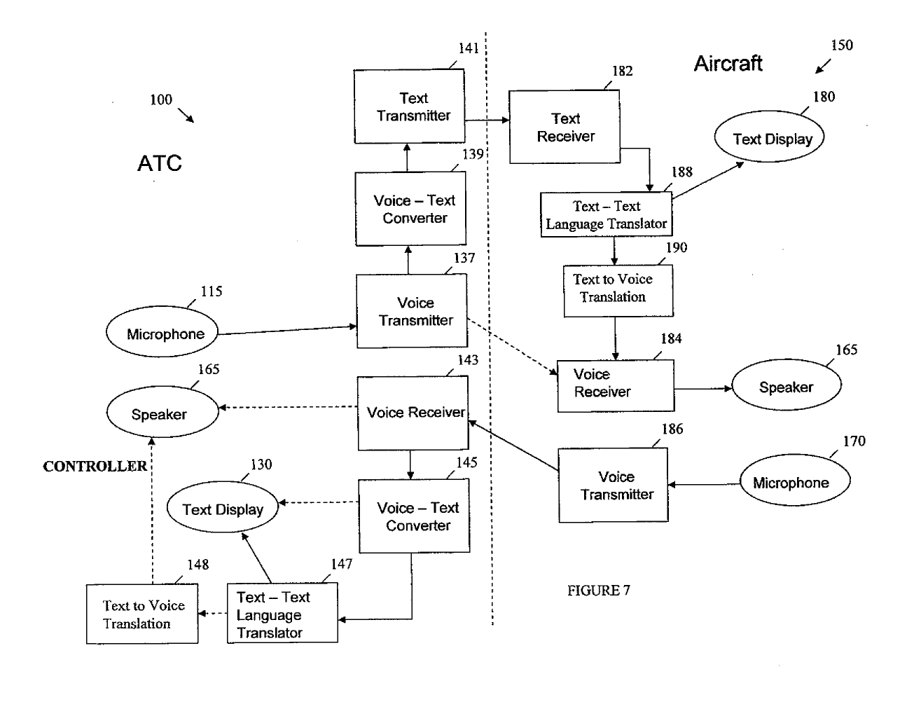

FIG. 7 is an embodiment of a communications system including a text to voice translation component, according to principles of the invention. This embodiment is similar to the embodiment of FIG. 6 except the database is not explicitly shown (but is considered a part of this embodiment) and includes a text to voice translation components 148, 190. The text to voice translation provides yet another level of security so that a message may be read, but also heard in a language of the recipients choosing. The text to voice translation may be performed on any text message. A user option also allows for the text display to be different from the language being spoken, if circumstances warrant. This may involve two outputs (e.g., two files) being produced by the text to text translator 147, 188 in two different languages.

Moreover, the database features 131, 187 (as shown in FIG. 6) may optionally be components to any converter or any translator of any of the embodiments herein. These databases may serve for historical recall or for subsequent additional translations of a stored message thread or selected message. A message or message thread may be recalled, perhaps by using a search/recall parameter such as a particular tag (e.g., messages from a particular Air Traffic Control center, messages from a particular aircraft, messages with a particular date/time stamp range, or other tags.)

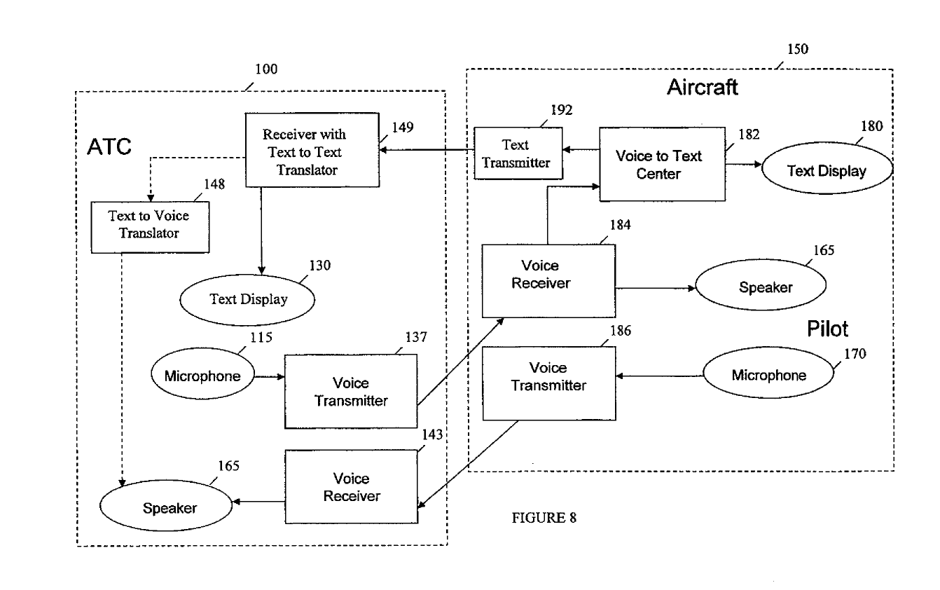

FIG. 8 is a functional block diagram showing an embodiment of a system for communication having a message confirmation loop, according to principles of the invention. In this embodiment once a voice transmitter 137 transmits a voice message to voice receiver 184, the voice receiver 184 provides the voice to the voice to text center (or converter) 182 for display. To provide a confirmation feedback loop to the originator (such as a ground controller at microphone 115), the voice to text center 182 provides the text to a text transmitter 192 for relaying to the ground control portion 100 where a text receiver and optional text to text translator 149 receives the text from text transmitter 192 where the text is output to display 130 (with or without another translation). In this way, a controller can verify that the received message from receiver 149 functionally matches the meaning of the originally sent message (these messages may be identifiable/matched by a message number). The system may also generate message numbers automatically on outgoing messages so that the messages that are received in return (e.g., translated messages) bear the same or equivalent identifier. In an alternate embodiment, the ground portion 100 may translate a voice message to text and tag the message with an identifier prior to transmission to an aircraft which will be included in a return confirmation loop so that the system may automatically display both the original message and the received translated message (which may have undergone more than one translation) for verification.

In some embodiments, the originating voice transmission may also bear an identifier to identify the message, perhaps using a sub-tone or other unobtrusive tagging method, so that any returned translated message in the confirmation loop can be quickly matched to the original message for visual display and verification.

In the embodiments employing voice to text converters (or translators), voice may be converted into a format that enables printed text to be generated, preferably in real time or with a delay that is not disruptive to processing of the voice and text data to the controller, pilot or crew member. Preferably, the voice message and the converted text message are substantially output in real time so the recipient is unencumbered to recognize the correlation of the two outputs as being the “same” message. Voice may be converted in one of several places; either the transmitting station or the receiving station, or both.

In alternate embodiments (not shown), the translation might take place at a different intermediate location (perhaps a logically centralized server or processing center which may be servicing multiple communication channels on demand involving a plurality of aircraft and/or controllers) and transmitted to the parties (i.e., appropriate ground control and/or aircraft). This may be a useful arrangement particularly if an aircraft (or ground location) is not equipped with a particular type of language translator that is required for a situation, perhaps a situation that is not routinely encountered. In this way, a centralized translator which may have more capability to perform different types of translations may be called upon to perform a particular translation for the infrequent situation. The intermediate location might also simply act as a backup facility in case of unavailable translating resources at a ground location or on an aircraft, perhaps simply due to being temporarily non-operational.

The converted voice inputs may be transmitted to and then decoded and/or displayed by the receiving station where the converted information is made available to the end user as voice, printed text and/or both. Alternatively, the voice to text converted signal may be encoded and also encrypted at the sender's locality prior to it being transmitted to the receiving station where it may be displayed as text (and/or graphics) to the end user or crew member, typically as an adjunct to the simultaneous audio reception of the transmission. In the simultaneous text and voice embodiments, raw voice data may be transmitted to the receiving unit where it would then be converted for use as voice, printed text and/or both.

For aviation communications having direct communications between ATC and pilots, a visual display of communications is helpful to enhance understanding and interpretation. Additionally, in some embodiments, selected text data may be isolated and utilized by aircraft flight management systems to ease pilot workload and reduce communications errors. This is not the same as voice activation; rather, it is the conversion of voice to text information containing discreet meaningful data (typically identifiable pre-defined words or phrases) which can be manipulated and linked by the pilot to other avionics in a very efficient and ergonomic way.

The embodiments of the invention described above may also aid in reducing the radio frequency (RF) congestion currently existing. Pilots may acknowledge ATC instructions/message by pushing a button, or saying “roger”, etc., thereby signaling to ATC receipt of and acceptance of information without a full read-back or the message.

Many embodiments herein may also aid communication between aircraft and controllers during (involving) international flights. Areas problematic in an international aviation communication environment is language barriers and the difficulty many pilots have understanding spoken English. The English text augmentation should serve these pilots especially well by providing to foreign pilots an option of having the transmitted voice signal translated to the receiving pilot's native language as text. Therefore this pilot would hear the standard English of ATC and have it verified in his/her own textual language.

Severe noise environments diminish/degrade the capability of the listening party to the point where communications are difficult, if not impossible. The redundancy of printed text enables the message to be received and understood. This would include environments of extreme severity where the listener's capacity to hear would be temporarily or permanently compromised, i.e., aircraft sudden decompression, wind screen or cock pit structural breech, construction sites, engine rooms, combat, and the like.

In the aviation industry, reliability of data transmission and understanding is important as discussed briefly above. As such, the avoidance of errors in the receipt and processing of ATC information is important. The source of such errors may be caused by several factors, and may result in the transmitted information being unintelligible to the pilot, or may result in an apparent conflict between what the pilot has heard, or believes the pilot has heard, and the translated displayed textural information that an embodiment of the present invention has provided. In either situation, the pilot may simply ask that the information be repeated until concurrence between the audibly transmitted and textually displayed information occurs. A further systems check may be the display of the audio to text conversion to the very same controller who initially spoke the audio, thereby confirming the text accuracy before sending it to the aircraft with a send accuation button.

In another aspect of the invention, the translation of the spoken information to text may also include a component that can identify to a pilot the degree of assurance or certainty that the information translated corresponds to the received. In other words, the system may provide an indication of its internal level of confidence that the information it translated is, in fact, the information received. The indication may be provided by displaying the textural information in different colors. For example, if the translating component (e.g., 125, 182, 147, 188, etc.) is certain that what it has translated is, in fact, what it had received; the textual information may be displayed green. If, however the translating component only has between, for example, a 99% to 96% level of confidence that the information it has translated is, in fact, what it had received, the textual information may be displayed in another color, for example, amber. For lower levels of confidence, the textual information may be displayed in yet another color, for example, red. If the confidence is so low, a display may not be provided whatsoever, or a fault, error, or other message may be displayed indicating to the pilot or user that the translation could not be completed. Other indications such as lights, flashing display, different font or font characteristics, etc. may be used.

The confidence display is typically generated for certain types of information. That is, the criticality of the correctness of certain information may be high, while certain other information may not be as high such that a slight mistranslation may not affect the flight safety or other critical elements. For example, common speech idioms such as “augh” and “and” do not convey important information, and therefore a mistranslation thereof may not be of concern to a pilot or other user. However, other information, for example, numeric information, may, in fact, be important such that a display of the systems confidence level in a correct translation may be important to a pilot or other user.

In the embodiments of the invention, not all numeric information may be rated with a confidence indication, but only that information which communicates safety or other critical or important information. For example, while both altitude information and radio frequency information may be important to a pilot or other user, an error in the selected altitude may lead to drastic results as opposed to an error in the radio frequency designation, which simply will require the pilot to re-seek the frequency information if an error is made. In such a situation, the altitude information may be displayed along with the confidence indication as described above while the frequency information need not utilize such a confidence indicator.

In embodiments having a confidence check, the confidence indication may be provided by a separate unit or device (not shown) (“confidence unit”). This device simply monitors communication and would provide a visual indication relating to its confidence that it could have properly translated or otherwise understood the verbal communication. Such a unit provides the pilot with a level of confidence that the information that the pilot or user may have spoken or may have heard is likely to be properly interpreted. In other words, while a pilot may be relatively certain that he or she heard a particular command, if the confidence unit does not translate that command into textual information or otherwise could not have reliably understood the spoken command, a visual indication of the level of confidence may be provided so that the pilot can either ask for a repeat of the command or may repeat the command that the ATC had issued. Such visual indication may take the form of a light indicator, for example, utilizing the red/amber/green system discussed above, or may simply display a textual warning message. The confidence unit may also issue an audible alert that would indicate a low level of confidence that the command received or transmitted could be properly interpreted by a user. Such confidence levels may presently be derived from existing voice to text statistical acoustic and language software that are employed and refined in the various embodiments herein to predict probabilistically the flow of linguistic information in a given aviation communication environment.

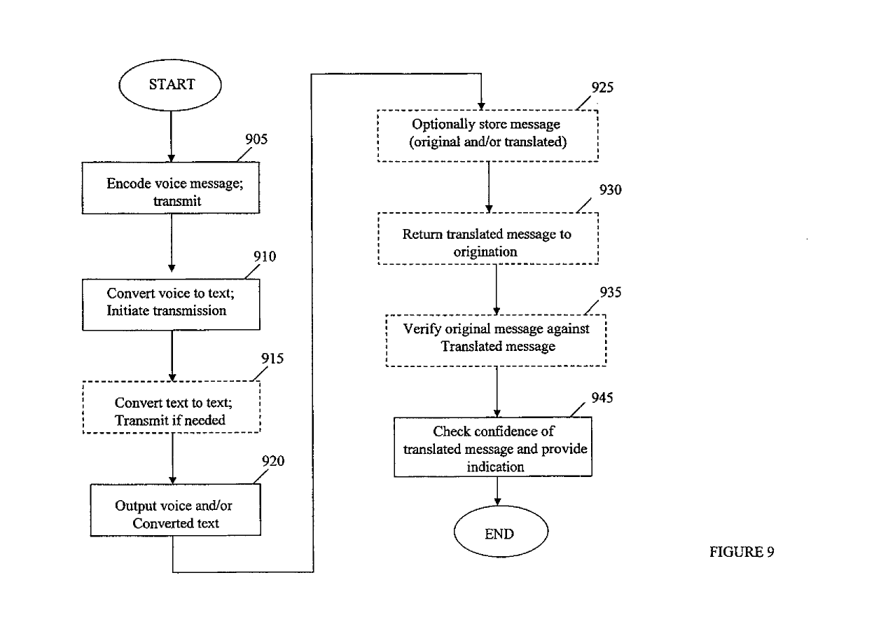

FIG. 9 is a flow diagram showing steps of an embodiment for using a communication system, according to principles of the invention. The flow diagram of FIG. 9 and any other flow herein may also represent a functional block diagram representing the components for performing the respective steps. The components may be implemented in part as software executing on a suitable computer processing platform having appropriate input and output. The components may have executable code that performs one or more of the steps when executed and may also reside on a storage medium including memories such as random access memory (RAM) and/or read-only memory (ROM), disks, DVDs, CDs, or databases, and the like.

At step 905, a voice transmission may be encoded for transmission and transmitted to a destination. The destination may be a vehicle such as an aircraft, a centralized server that may be servicing a variety of different clients, or a ground control center. At step 910, the voice may be converted from voice to text either at the source of the transmission or at the receiving destination of the voice transmission. The text is then transmitted to a display device, or otherwise transmitted to a destination such as an aircraft or a ground control center for eventual display to a display device, as appropriate. At optional step 915, the text may be converted to text in yet another language and optionally transmitted to a destination, if needed. The text conversion may take place at the source, destination, or at a centralized server. At step 920, the text and/or voice may be output to an appropriate device so a user may hear and/or view the message.

At optional step 925, the voice and/or translated text message(s) may be stored in a database for later recall. The message may bear a message identifier for later searching and matching to a corresponding message bearing the same or equivalent (possible enhanced) identifier. At optional step 930, the translated message (to text) is returned to the originating location such as a air traffic control facility that typically initiated the original message. At step 935, the returned translated message may be verified against an originally transmitted message for verification purposes. This may involve an automatic type search and matching function to identify and correlate the translated message with an originally transmitted message. A database may be involved that is used to dynamically store and retrieve sent and received messages. The messages may be tagged with identifiers such as time stamps, originating source (e.g., a particular ATC and/or particular controller), destination recipient or recipients (e.g., broadcast messages may have been received and translated by more than one aircraft) and/or types and numbers of translation instances. At step 945, a confidence check may be preformed on the translated messages to determine a degree or level of translation confidence. The confidence level determination may be configured at least in part to base its level of confidence on the number of hits of pre-determined words of phrases encountered during the translation process. An indication of the level or degree of translation may be displayed or signaled to a user. The process ends.

The system and methods herein may also be equally applicable to other personal, business, combat and industrial environments where the voice/audio signal is affected or compromised by factors such as ambient noise, multiple rapid transmissions by multiple speakers on one radio frequency and voice and linguistic stressors which affect the verbal output of the senders and the psycho cognitive limitations of the receivers of such information.

While the invention has been described in terms of exemplary embodiments, those skilled in the art will recognize that the invention can be practiced with modifications in the spirit and scope of the appended claims. The examples given above are merely illustrative and are not meant to be an exhaustive list of all possible designs, embodiments, applications or modifications of the invention.

I claim:

1. A system for providing enhanced communication between a control center and a vehicle, comprising;
a voice to text converter to convert a voice based message to a text based message;
an output display unit in the vehicle configured to display the text based message converted from the voice based message; and
a speaker configured to audibly deliver the voice based message.

2. The system of claim 1, wherein the voice to text converter converts at one of the control center and a centralized server and is configured to initiate transmission of the text based message to the vehicle.

3. The system of claim 1, wherein the voice to text converter is configured to convert a message from voice to text at the vehicle and after reception of the voice based message.

4. The system of claim 1, further comprising a text to text converter configured to convert the text based message converted from the voice based message from a first text language to a second text language.

5. The system of claim 4, wherein the text to text converter converts at the vehicle.

6. The system of claim 1, wherein the text based message is displayed to an originator of the voice based message for visual verification of the text based message against the voice based message.

7. The system of claim 6, wherein the text based message is transmitted only after an actuation signal by the originator.

8. The system of claim 6, wherein the text based message is received from the vehicle for display to the originator at the control center.

9. The system of claim 6, further comprising a text to text converter configured to translate the text based message from one language to another language.

10. The system of claim 1, wherein the vehicle comprises an aircraft.

11. The system of claim 1, further comprising a confidence checking component that determines a confidence level of the text based message converted from the voice based message.

12. The system of claim 7, wherein the confidence level is displayable on the display unit to visually indicate a degree of confidence of the text based message.

13. The system of claim 1, wherein the voice based message and text based message are output substantially in real time.

14. The system of claim 1, further comprising a text to voice converter configured to convert the text based message to an audible message.

15. A method of providing enhanced communications between a controller and a vehicle, the method comprising the steps of:
translating a voice message to a text message;
displaying the text message converted from the voice message; and
outputting the voice message to a speaker,
wherein the outputting of the voice message and the displaying of the text message occur substantially at the same time.

16. The method of claim 15, wherein the translating occurs prior to transmission of the text message to the vehicle.

17. The method of claim 15, wherein the translating occurs at the vehicle.

18. The method of claim 15, further comprising the step of converting the text message translated from the voice message from a first language to a second language.

19. The method of claim 15, further comprising displaying the text message to an originator of the voice message for visual verification of the text message.

20. The method of claim 19, wherein the text based message is received from the vehicle for display to the originator.

21. The method of claim 15, wherein the vehicle is an aircraft.

22. The method of claim 15, further comprising the step of performing a confidence check to determine a confidence level of the text message converted from the voice message and displaying the confidence level.

23. The method of claim 15, wherein the translating step is performed by a server configured to translate the voice message to the text message for clients that include at least one of the vehicle and the controller.

24. A method of providing enhanced communications between a controller and an aircraft, comprising the steps of:
receiving a voice message at the aircraft;
translating the voice message to a text message;
determining a confidence level of the translating; and
outputting the text message, the confidence level and the voice message substantially at the same time for use by a crew member of the aircraft.

25. The method of claim 24, further comprising the step of storing the text message for subsequent recall.
